(19) United States
(12) Patent Application Publication
(10) Pub. No.: US 2008/0310928 A1
(43) Pub. Date: Dec. 18, 2008

(54) Multi-purpose support table for a router

(76) Inventor: Robert Winge, Newburgh, IN (US)

Correspondence Address: Gary K. Price, Esq.;Bowers Harrison, LLP, 25 N.W. Riverside Drive, P.O. Box 1287, Evansville, IN, 47706-1287, US

(21) Appl. No.: 12/157,991

(22) Filed: Jun. 16, 2008

Related U.S. Application Data
(60) Provisional application No. 60/936,124, filed on Jun. 18, 2007.

(51) Int. Cl. B23D 7/08

(52) U.S. Cl. 409/224

(57) ABSTRACT

A multi-purpose support table for a router having a base, and a table subassembly that includes a primary work surface pivotally attached to the base, a fence affixable perpendicularly with respect to the primary work surface, and a router mounting plate attached to the primary work surface and adapted to receive a router. The tilting mechanism enables the table subassembly to be pivoted relative to the base and locked in a first position where the primary work surface is generally horizontal and a router axis is oriented vertically, or a second position where a fence work surface and the router axis are generally horizontal. The fence work surface can be positioned with respect to the primary work surface in order to allow precise beveled cutting of the workpiece. The fence further includes a tower and at least one sliding member that can receive various cutting tools and can be slidably positioned along the length of the tower.

### CROSS REFERENCES TO RELATED APPLICATIONS

U.S. Provisional Application for patent No. 60/936,124, filed Jun. 18, 2007, with title “Multi-Purpose Support Table for a Router” which is hereby incorporated by reference. Applicant claims priority pursuant to 35 U.S.C. par. 119(e)(i).

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates generally to woodworking and more particularly to a router table for use in cutting various types of joints, shapes, and articles from wooden workpieces, as well as other precision woodworking operations. More particularly, the present invention includes an improved adjustable fence for positioning and guiding the cutting tool of the router or the work piece.

2. Brief Description of Prior Art

Router tables are widely used because of their ability to make more precise cuts than can be made by hand. A router table is typically a horizontal work surface under which a conventional router may be mounted in order to use it as a shaper by moving a workpiece relative to the router bit, rather than moving the router bit relative to the workpiece. Often, such router tables are inconvenient to use because adjustment of router bit position must be accomplished by adjusting the router on its base, which is difficult to do with the router mounted upside down underneath a router table.

To maintain the workpiece in position relative to the cutter bit, some prior art router tables are provided with elongated fences that are connected to the top of the main table so that they can be moved laterally toward and away from the cutter bit. In this type of arrangement, it may be cumbersome and potentially dangerous for a user to attempt certain horizontal cuts while manually holding the workpiece against the fence in a position perpendicular to the main table.

What is needed is a router table that allows safe and convenient positioning and securing of a workpiece in positions perpendicular to the main table while allowing simple and accurate adjustment of the router bit with respect to the workpiece.

As will be seen from the subsequent description, the preferred embodiments of the present invention overcome disadvantages of the prior art.

### SUMMARY OF THE INVENTION

In accordance with the present invention, a multi-purpose support table for a router is disclosed. The present invention overcomes the above-referenced shortcomings of prior art router table assemblies by providing a router table design which includes a tiltable table subassembly. The subassembly includes a primary table and fence which can be tilted together. As will be seen, this configuration allows universal positioning of the router axis with respect to the base. In this manner, positioning and precision cutting of an elongate workpiece parallel or perpendicularly with respect to the router axis is accomplished accurately and efficiently, and adjustment of the router bit is performed conveniently.

A router table in accordance with the present invention includes a base, a table subassembly, and a tilting mechanism for tilting the table subassembly from a first position or horizontal position, to a second position or vertical position, with respect to the base. The table subassembly includes a primary work surface pivotally attached to the base, a fence affixable perpendicularly with respect to the primary work surface, a router mounting plate attached to the primary work surface and adapted to receive a router, and means to enable a user to transversely vary the position of the router mounting plate for router bit adjustment. The tilting mechanism enables the table subassembly to be pivoted relative to the base and locked in the described two (2) positions, the first position where the primary work surface is generally horizontal and the router axis is oriented vertically, and the second position where as will be described, a fence work surface and the router axis are generally horizontal.

More specifically, the present invention provides a router table comprising a base with a primary table pivotally attached to the base and shiftable between a generally horizontal position and a generally vertical position. The primary table includes a generally planar primary work surface. The fence is affixable perpendicularly with respect to the primary work surface. The fence includes a generally planar fence work surface, which like the primary work surface, can support a workpiece. The workpiece is moveable along a longitudinal axis parallel to the primary table and fence. The router mounting plate is shiftably attached to the primary table adjacent a slot extending through the primary table. The mounting plate is adapted to receive a router, and includes an aperture formed through the support surface in alignment with the slot extending through the primary table to enable a rotary cutting tool mounted in a router to extend beyond the primary table support surface to engage a workpiece.

The tilting mechanism enables the table subassembly, including the primary work surface, the fence, the router mounting plate, and the router to be pivoted relative to the base and locked in position. In the primary position, the primary work surface is generally horizontal and the router axis is oriented vertically, and in the second position, the fence work surface and the router axis are generally horizontal.

The fence work surface can further be positioned with respect to the primary work surface in order to allow precise beveled cutting of the workpiece between zero degree. and ninety degree. In this regard, the fence work surface includes an end that provides degree indicators. The fence further includes a tower that is adjacent and in opposing relationship to the fence work surface. The tower includes at least one sliding member that can receive various cutting tools and can be slidably positioned along the length of the tower.

### BRIEF DESCRIPTION OF THE DRAWINGS

FIG. 1 is a front perspective view of a preferred embodiment of the present invention, a multi-purpose support table for a router.

FIG. 2 illustrates the fence work surface frame with the flat work surface removed.

FIG. 3 is a front view of the fence.

FIG. 4A illustrates the router table in a first position with the work surface frame in a horizontal position.

FIG. 4B illustrates the router table in a second position with the work surface frame in a vertical position.

FIG. 5 shows a cross-sectional view of a portion of the fence.

FIG. 6A is a top view of the vacuum control mechanism.

FIG. 6B is a cross-sectional view of the vacuum control mechanism.

FIG. 7A shows an end view of the table pivot mechanism.

FIG. 7B shows a cross-sectional view of the table pivot mechanism.

FIG. 8 illustrates the router table in a second position and where the fence work surface is angularly adjusted.

FIG. 9 illustrates the router table in the second position.

### DESCRIPTION OF THE PREFERRED EMBODIMENT

The multi-purpose support table for a router of the present invention is directed to a router assembly configuration that allows universal positioning of the router axis with respect to the base. Specifically, it will be noted in the drawings that the assembly of the present invention provides a means for positioning and precision cutting of an elongate workpiece parallel or perpendicular with respect to the router axis. In the broadest context, the assembly of the present invention consists of components configured and correlated with respect to each other so as to attain the desired objective.

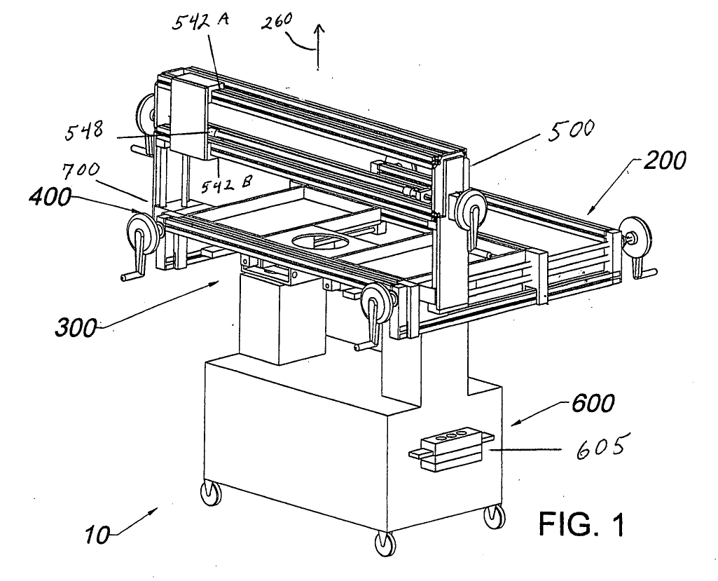

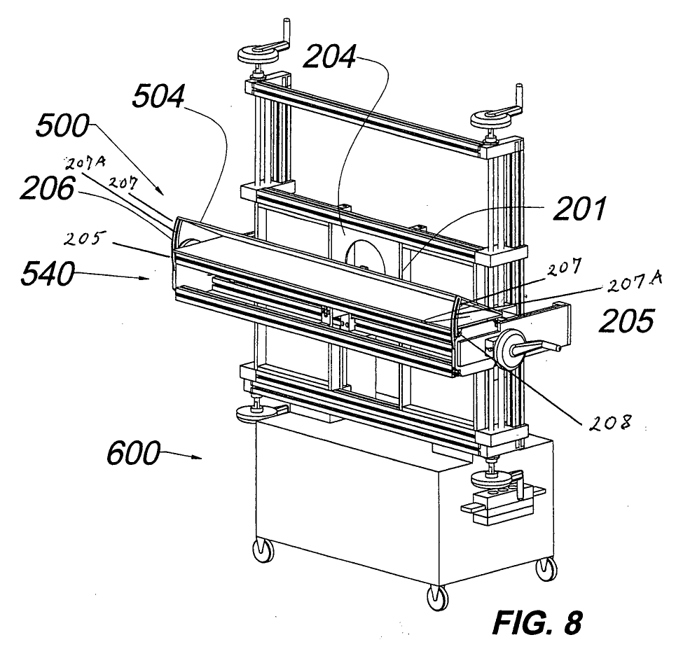

FIG. 1 illustrates a preferred embodiment of a multi-purpose support table for a router made in accordance with the present invention. A tilting router table 10 is generally shown in the perspective view of FIG. 1. The tilting router table 10 includes a base 600 which pivotably supports a primary work surface frame 200. A fence 500 is releasably and movably attached perpendicular with respect to the primary work surface frame 200. A router (FIG. 8) is attached to the primary work surface frame 200 by a router mounting plate 204. An adjustable mechanism 400 is provided for adjusting position of the router 202 and router mounting plate 204 with respect to the primary work surface frame 200. The adjustable mechanism 400 can be used in positioning the router mounting plate 204 in addition to being used while the router is engaged in work piece.

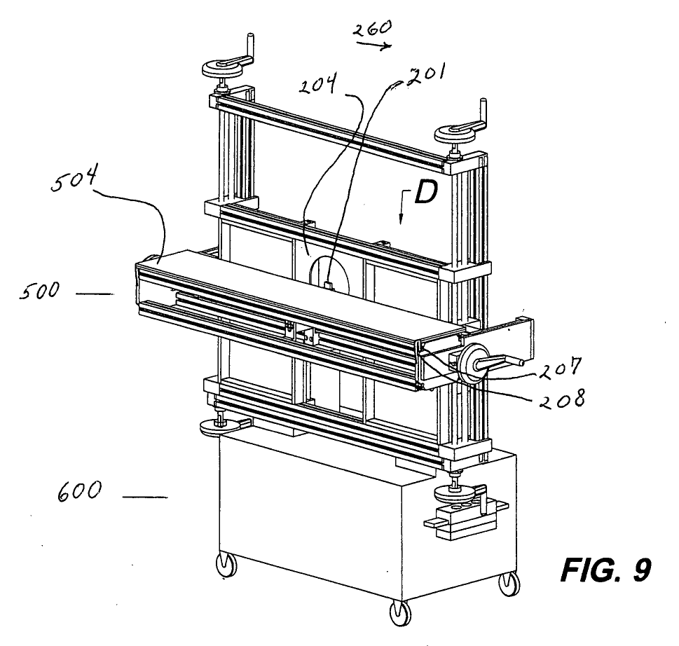

FIG. 1 shows the work surface frame 200 with the actual work surface 201 (see FIG. 9) removed for clarity.

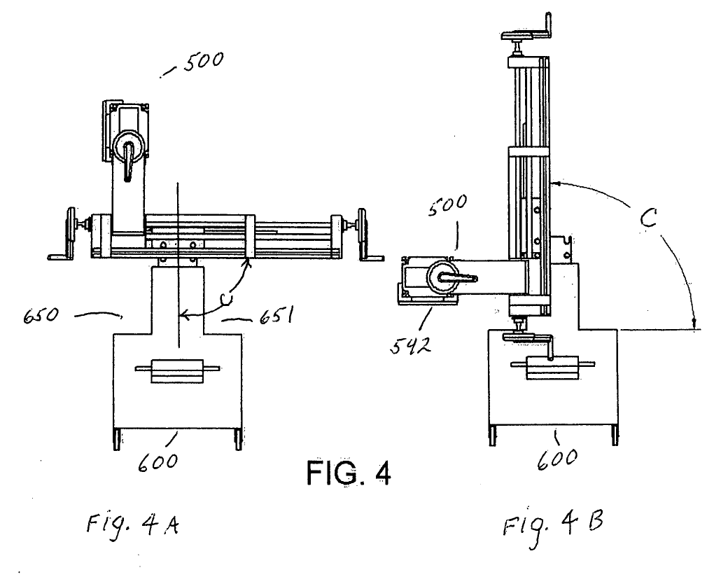

A tilting mechanism 300 enables the table subassembly 700, which includes the primary work surface frame 200 fence 500, router 202, router mounting plate 204 and adjustment mechanism 400 to be pivoted relative to the base 600, and locked in an angular position. In a first or primary position, shown in FIG. 1, the primary work surface frame 200 is generally horizontal and the router axis 260 passing through the router bit (not shown) is oriented vertically. In a second position, shown in FIG. 4B, the fence 500 and the router axis 260 are both oriented generally horizontally.

The primary work surface frame 200 is a generally planar surface with a transverse slot 402 that holds the moveable router mounting plate 204. The fence 500 also includes a generally planar fence work surface 504 (best shown in FIGS. 8 and 9). The fence work surface 504 collectively with the primary work surface frame 200 would support a work piece (not shown), the work piece being moveable along a longitudinal axis parallel to the primary work surface 201 and fence 500.

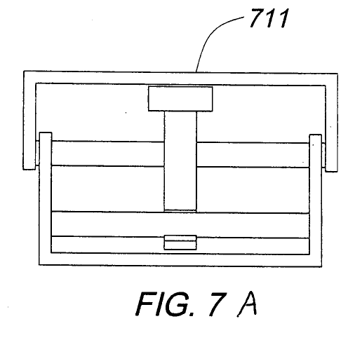

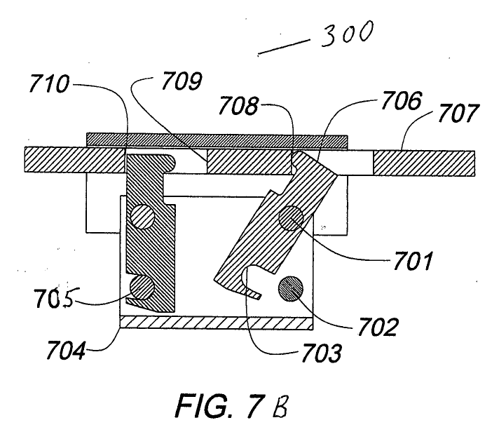

In order to accomplish tilting movement of the table assembly 700 with respect to the base 600, the tilting mechanism 300 is provided (see FIG. 7 for details). The tilting mechanism 300 includes a lock member (FIG. 7) which is secured to the primary work surface 201. The lock member releases the primary work surface 201 so that the surface 201 is pivoted to either the previously described first position (shown in FIG. 1) or the second position (shown in FIG. 9), at which point the lock member secures the primary work surface 201 at the selected position with respect to the base 600.

It is understood that in the second position, where the fence work surface 504 and the router axis 260 are generally horizontal, alignment and adjustment of the router bit is performed conveniently. As shown in FIG. 9, the user is able to site down (designated as arrow “D”) on the work area without having to bend over.

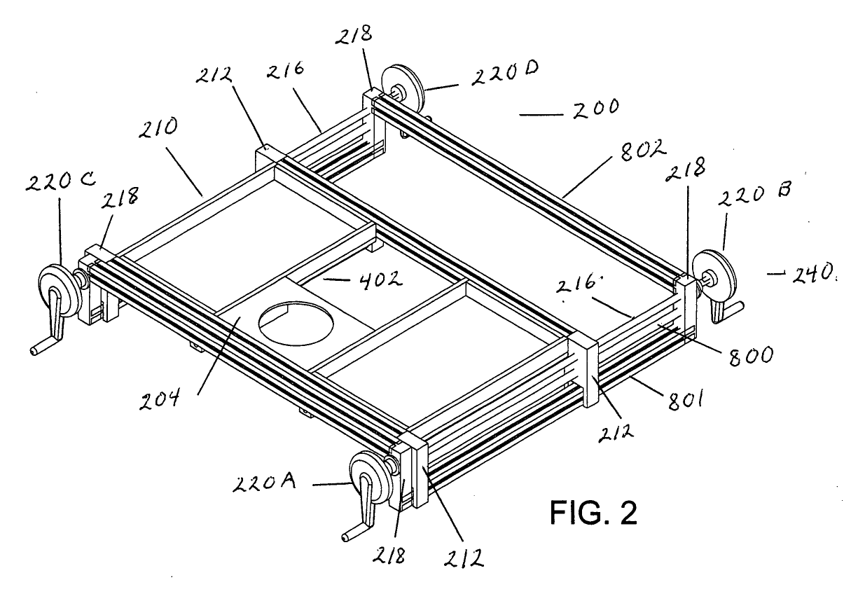

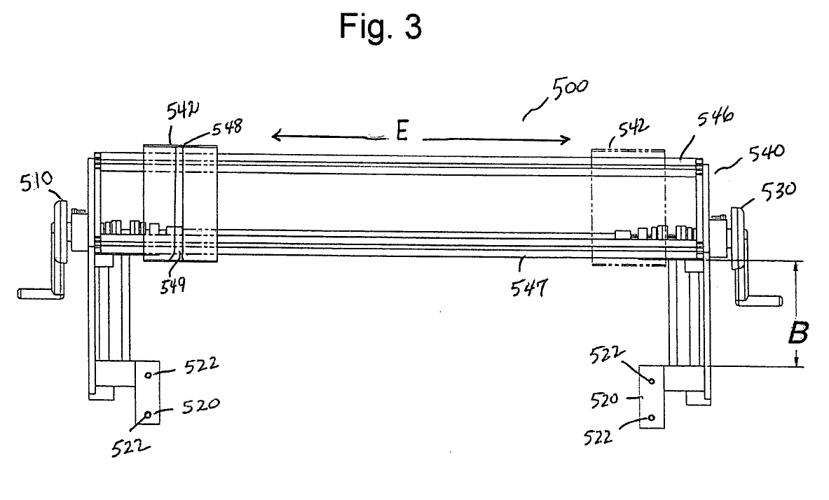

FIG. 2 shows details of the work surface frame 200 with the actual flat work surface 201 removed. The work surface frame 200 includes a moveable sub-frame 240. The moveable sub-frame 240 is mounted on blocks 212. Each threaded rod 216 includes a hand wheel 220 at each end such that turning the hand wheel 220 moves the fence 500 thereby adjusting the position of the router. Hand wheels 220 can include indicators to show distance of fence 500 travel. Handle 220A is attached to an acme threaded rod 216 that passes through block 212 freely. Acme rod 216 is threaded through block 520 (FIG. 3). Handles 220A and C are connected by means of chain and sprocket to ensure precision timing and equal motion of the 216 acme assembly.

In FIG. 2, block 218, shaft 800 and 801 are bolted together and move as an assembly 240. Bar 802 connects this assembly 240 together. By turning any of the handles 220, this changes the relationship between block 218 and fence 500 (FIG. 3). FIG. 2 subassembly 210 and block 212 are stationary as they are mounted to the base 600 via pivot pins. Bearings 212 that are around linear shaft 800 allow assembly 200 to slide. There are locks located in 212 in order to lock assembly 200 in position. Linear shaft 800 also passes through 520 (FIG. 3) by means of linear bearings.

FIG. 3 shows details of the fence 500. The fence 500 includes two mounting blocks 520 having threaded holes 522 that threadingly mount the fence 500 to the rotatable threaded bars 216 as previously described. The fence 500 includes a hand wheel 530 that allows for movement of sliding member 542 along the length of the fence indicated by “E”. It will be clear from FIGS. 1 and 4 that the sliding member 542 can be removed and placed on the other side of the fence 500 so that the sliding member 541 which is shown under the fence 500 in FIG. 4B can be moved to be on top of the gantry fence 500 so that a work piece could work on the fence work surface 504 (FIG. 9).

FIG. 4 includes a first view 4A with the table subassembly 700 in a first position with the work surface frame 200 in the horizontal position and a second view 4B with the table subassembly 700 in a vertical position where the router easier to access and where the fence 500 is big enough to act as a work surface to support a work piece for all but the biggest projects. The angle “C” represents the angle through which the table subassembly 700 rotates.

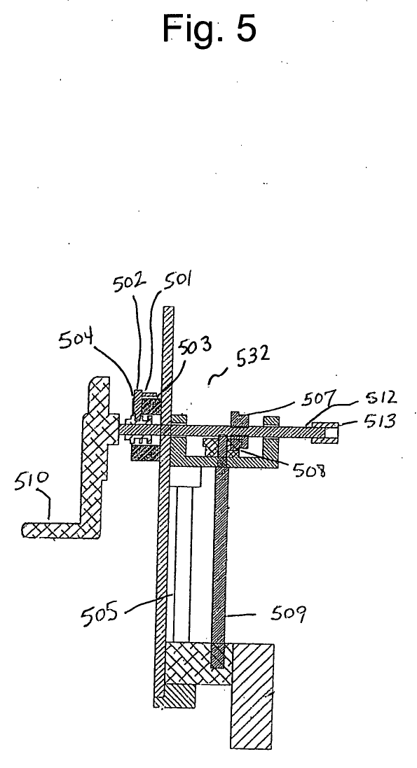

FIG. 5 shows a cross-sectional view of a portion 532 of the gantry fence 500. The mechanism 532 adjusts the height (“B” in FIG. 3) of the fence 500 relative to the router mounting plate 204. Cam 501 is linearly attached but free to spin around the shaft 512. Housing 503 houses but allows rotation of cam 501 by traveling linearly within 503. When gears 507, 508 mesh, turning handle 510 will cause acme 509 to turn to adjust the height B, rod 505 acts as a guide. When gears 507, 508 are out of mesh, will be used to feed auxiliary tools by attachment of acme 509 to the free end 513 of shaft 512. Tools thus attached can run parallel to gantry fence 500.

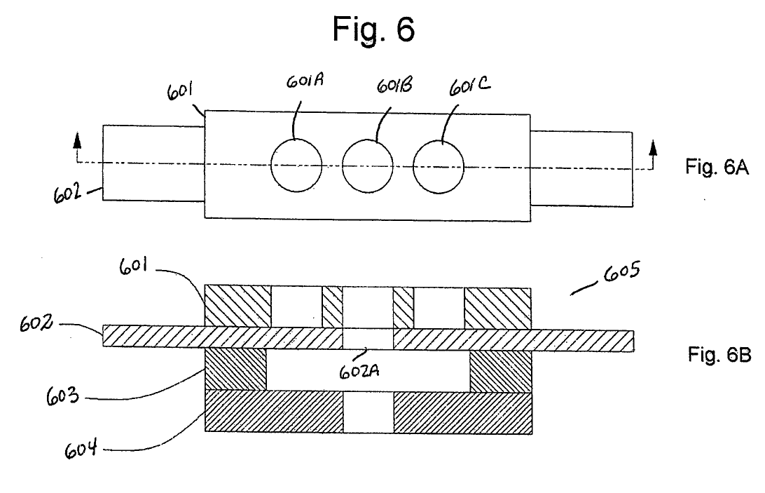

FIG. 6 shows the vacuum control mechanism 605 which includes a vacuum supply block 604 connected to a source of vacuum (not shown) in the base 600 which can be used to vacuum away sawdust particles. The vacuum control includes a vacuum manifold block 603 and a slider block 602 that allows for selective control of vacuum from the manifold to any of three (3) vacuum outlets in vacuum outlet block 601. This allows for the user to selectively provide vacuum to any of the three (3) tool locations so for example, the vacuum outlet 601A could be piped to vacuum dust away from the router in the position shown in FIG. 4A and the outlet 601C could vacuum dust away from the router in position 4B. All the operator would need to do is slide bar 602 to align opening 602A with the selected vacuum outlet. Alternatively, the manifold could vacuum from more than one location when several tools are used.

FIG. 7 shows two views 7A and 7B of the table pivot mechanism 300. FIG. 7A shows an end view and 7B a cross-sectional view of the table pivot mechanism 300 that includes two (2) cam locks 706 and pivot pin 701. Each lock 706 includes a locking bar 702 and 705 and a pivot bar 701. In the position shown in FIG. 7B, the bracket 711 is free to pivot in a first direction angle “C” in FIG. 4B. As can be seen in FIG. 7B, a slider bar 707 can slide to the left to lock catch 703 around bar 702. In a center position not shown, the cam operator surfaces 708 and 709 are spaced from the cam locks 706 such that the table subassembly 300 is locked against movement in either direction. Further, movement of the slider bar 707 to the left will release the left cam lock from bar 705 such that the bracket 711 and the table subassembly can rotate in the opposite direction, indicated by C′ in FIG. 4A. Thus, the fence 500 can be used to the left of base 600 as shown in FIG. 4A or to the right (not shown) for right or left handed operations. The base 600 includes notched out areas 650 and 651 (FIG. 4) to accommodate the fence 500 depending upon the direction it is rotated.

FIG. 8 illustrates the router table 10 in the second position and where the fence work surface 504 is angular adjusted. The fence work surface 504 can be positioned with respect to the primary work surface 201 in order to allow precise beveled cutting of the workpiece. The fence work surface 504 can include an arced member 207 having an arced slot 207A that is further attached to tower 540. The arced member 207 includes an end 205 that provides degree indicators 206. The degree indicators 206 indicate the angles of cut with respect to the primary work surface 201 as the workpiece is moved along the longitudinal axis parallel to the primary table 201 and fence 500. The tower 540 further includes a lockable bolt 208 that passes through the slot 207A in order to selectively lock the surface 504 in the desired angular position. It should be understood that the fence work surface 504 can be adjusted as described regardless of whether the table assembly is in the described first position or second position.

FIGS. 1 and 3 illustrate the fence 500 without the fence work surface 504. As illustrated in FIG. 3, the fence 500 includes a tower generally designated as 540 that is disposed adjacent the fence work surface 504. The tower 540 is generally defined by elongated upper and lower bar members 546, 547. At least one sliding member 542 (best shown in FIG. 3) can be selectively positioned along the length of the tower 540. More particularly, the sliding member 542 includes upper and lower slots 542A, 542B (see FIG. 1), respectively, which slots are sized to receive the upper and lower bar members 546, 547 of the tower 540. As should be understood, the upper bar member 546 is received within the upper slot 542A of the sliding member and the lower bar member 547 is received within the lower slot 542B of the sliding member 542.

The sliding member 542 further includes a lock 548 (FIG. 1) for securing the sliding member 542 at a selected location along the length of the tower 540. The sliding member 542 further includes a mount 549 designed for receiving various cutting tools.

In application, when the table 10 is in the described first position, the primary work surface 201 serves as the conventional table and the fence work surface 504 serves as the conventional fence. In the second position as illustrated in FIGS. 8 and 9, the fence work surface 504 serves as the conventional table and the primary work surface 201 serves as the conventional fence. Either side of the fence 500 can hold the work surface making the tool equally useful for right or left handed users. The easy access to the handles 510, 520, 530 keeps the operators hands free to secure the work piece when moving through a cutter head in the router. When large work pieces are secured or clamped to the work surface, user can power feed by engaging quick release 502 on gentry fence 500 and using handle 510 to fee the work piece to the router.

The machine 100 can accommodate at least three (3) tools ready for use at any time.

As shown in FIG. 1, the dust collection system 605 is provided and is disposed in the base 600 in order to capture sawdust from a work piece. The dust collection system 605 provides a means for collecting sawdust immediately adjacent the cutter head using a conventional workshop vacuum system, not shown.

The tilting router table 10 enables convenient and accurate cutting of the work piece in a variety of orientations.

While the best mode for carrying out the invention has been described, those familiar with the art to which this invention relates will recognize various alternative designs and embodiments for practicing the invention. Thus, the above-described preferred embodiment is intended to be illustrative of the invention which may be modified within the scope of the appended claims.

I claim:

1. A tilting router table comprising:
a base that pivotably supports a primary work surface,
a fence releasably attached perpendicularly with respect to the primary work surface,
a router attached to the primary work surface by a router mounting plate,
an adjustable mechanism provided for adjusting position of the router with respect to the primary work surface,
a tilting mechanism enables the primary work surface, fence, router, router mounting plate and adjustment mechanism to be pivoted relative to the base,
said table having a first position where the primary work surface is generally horizontal and a router axis is oriented vertically, and a second position where the fence and said router axis are both oriented generally horizontally,
wherein said fence includes a generally planar fence work surface, adjusting means for angularly adjusting said fence work surface, and a tower defined by elongated upper and lower bar members, and
at least one sliding member selectively positioned along the length of said tower.

2. The table as recited in claim 1, wherein said base includes a source of vacuum and a vacuum manifold, a mechanical slide allows vacuum to be selectively applied from said manifold to a plurality of ports such that vacuum can be applied to said router in either said first position or said second position of said primary work surface.

3. The table as recited in claim 1, wherein said fence work surface can be removed from a first side of said fence and mounted on an opposite side of said fence.

4. The table as recited in claim 1, wherein said primary work surface can be tilted from said second position through said first position to a third position wherein said first work surface is vertical and said fence and said router axis are horizontal.

5. The table as recited in claim 1, wherein said router is under said work surface in said first position, and said router is exposed for adjustment in said second position.

6. The table as recited in claim 1, wherein said fence is mounted to said primary work surface by a rotatable threaded bar and wherein the position of the fence is controlled by a hand wheel connected to said threaded bar and wherein said fence includes a second hand wheel to control a position of the second work surface along a length of the fence.

7. An adjustable router table including:
an adjustable table subassembly, said adjustable table subassembly including a primary work surface and a fence adjustably supported perpendicular to said primary work surface, a router mounting plate secured to said primary work surface, said adjustable table subassembly moveable from a first position wherein said work surface is horizontal and a second position wherein said work surface is vertical and,
said fence having a second work piece supporting work surface that is horizontal in said second position of said adjustable table subassembly.

8. The table as recited in claim 7, wherein said primary work surface can be tilted from said second position through said first position to a third position wherein said first work surface is vertical and said fence and said router axis are horizontal.

9. The table as recited in claim 8, wherein said fence work surface can be removed from a first side of said fence and mounted on an opposite face of said fence.

10. The table as recited in claim 8, wherein said second work surface can be tilted through an adjustable angle relative to said router mounting plate.

11. The table as recited in claim 8, wherein said base includes a source of vacuum and a vacuum manifold, a mechanical slide allows vacuum to be selectively applied from said manifold to a plurality of ports such that vacuum can be applied to said router in either said first position or said second position of said primary work surface.

12. The table as recited in claim 8, wherein said router is under said work surface in said first position, and said router is exposed for adjustment in said second position.

13. The table as recited in claim 8, wherein said fence is mounted to said primary work surface and the position of the fence is controlled by a hand wheel wherein said fence includes a second hand wheel to control a position of the second work surface along a length of the fence.

14. A tilting router table comprising:
a base that pivotably supports a primary work surface,
a fence releasably and movably attached perpendicularly with respect to the primary work surface,
a router attached to the primary work surface by a router mounting plate,
an adjustable mechanism provided for adjusting position of the router with respect to the primary work surface,
a tilting mechanism enables the primary work surface, fence, router, router mounting plate and adjustment mechanism to be pivoted relative to the base, said table having a first position where the primary work surface is generally horizontal and a router axis is oriented vertically, and a second position where the fence and said router axis are both oriented generally horizontally and said fence and primary work surface are on a first side of said base,
wherein said fence includes a generally planar fence work surface.

15. The table as recited in claim 14, wherein said primary work surface can be tilted from said second position through said first position to a third position wherein said first work surface is vertical and said fence and said router axis are horizontal and said fence and primary work surface are on an opposite side of said base.

16. The table as recited in claim 15, wherein said fence work surface can be removed from a first side of said fence and mounted on an opposite side of said fence.

17. The table as recited in claim 16, wherein said second work surface can be tilted through an adjustable angle relative to said router mounting plate.

18. The table as recited in claim 17, wherein said router is under said work surface in said first position and said router is exposed for adjustment in said second position.
